(19) United States
(12) Patent Application Publication
(10) Pub. No.: US 2014/0104057 A1
(43) Pub. Date: Apr. 17, 2014

(54) HIGHWAY ALERT SAFETY KIT

(71) Applicant: THE FUTURE 33 LLC, Indianapolis, IN (US)

(72) Inventor: John Futrell, Indianapolis, IN (US)

(73) Assignee: THE FUTURE 33 LLC, Indianapolis, IN (US)

(21) Appl. No.: 14/116,789

(22) PCT Filed: May 11, 2012
(86) PCT No.: PCT/US2012/037408

§ 371 Date: Nov. 11, 2013

(51) Int. Cl. B60Q 7/00

(52) U.S. Cl. CPC B60Q 7/005
USPC 340/473; 40/612; 2/102

(57) ABSTRACT

HASK 10 is configured to alert other drivers on the highway to the presence of the stationary vehicle through the use of these major components and additional components. HASK 10 is also configured to assist other drivers to evade or avoid a hazardous condition by alerting other drivers of the stationary vehicle before other drivers reach the stationary vehicle.

### REFERENCE TO RELATED APPLICATIONS

The present application claims priority from U.S. provisional patent application Ser. No. 61/485,154, filed on May 12, 2011, with the title, “Highway Auto Safety Kit”, the disclosure of which is expressly incorporated by reference.

### FIELD

The present disclosure relates generally to highway safety, and more specifically, to a safety kit configured to alert other drivers about a stationary vehicle.

### BACKGROUND

When a vehicle stops, breaks down, or is otherwise in a disabled condition along the side of a road, highway, or interstate, a hazardous condition is created as other drivers continue to speed by. When a stationary vehicle is parked on or adjacent to a road, highway, or interstate, the vehicle may be obscured from the normal view of other drivers by obstacles, a bend in the road, or by other vehicles. This may create a dangerous situation for the occupants of the stationary vehicle.

A disabled vehicle typically requires an occupant to exit the vehicle to perform some level of repair. Alternatively a third party may come to assist the occupant. Finally, an occupant of a disabled vehicle must exit the vehicle in order to abandoned the vehicle. Whether the occupant exits the vehicle or third parties assist with the disabled vehicle, all participants are at a heightened risk of injury or even death as other drivers travel at high rates of speed near the disabled vehicle.

In light of the large number of vehicles which become disabled on the road, there is also a substantial need of an improved driver alert system which will aid the disabled vehicle to be visible to other drivers at a considerable distance. There is also a need for an improved driver alert system including at least some components which optionally can be operated from inside of the relative safety of the disabled vehicle. Such a system also should be capable of transmitting alerts to other drivers of other vehicles. Such alerts may include multiple mechanisms to early warning to notify the other drivers that a vehicle is stationary due to a breakdown.

Therefore, what is needed is a safety warning system that can be easily deployed and provide ample warning to oncoming traffic.

### BRIEF DESCRIPTION OF THE DRAWINGS

The above-mentioned and other features of this disclosure, and the manner of attaining them, will become more apparent and the disclosure itself will be better understood by reference to the following description of embodiments of the disclosure taken in conjunction with the accompanying drawings, wherein:

FIG. 1 illustrates a highway alert safety kit within a carrying case according to an embodiment of the present disclosure.

FIG. 2 illustrates the vehicle safety belt of the kit of FIG. 1. The belt is shown in operation on a vehicle's trunk.

FIG. 3 illustrates the warning sign and stand supporting a warning light. The sign, stand, and light are each parts of the kit of FIG. 1.

FIG. 4 illustrates the vehicle supported beacon of the kit of FIG. 1.

FIG. 5 illustrates a disabled vehicle on a highway shoulder utilizing the kit of FIG. 1.

FIG. 6 illustrates other driver's early visualization of the kit of FIG. 1 and the other's driver's actions to evade or avoid a hazardous condition.

Corresponding reference characters indicate corresponding parts throughout the several views. Although the drawings represent embodiments of the present disclosure, the drawings are not necessarily to scale and certain features may be exaggerated in order to better illustrate and explain the present disclosure.

### SUMMARY

The present disclosure generally relates to a highway alert safety kit comprising a vehicle safety belt configured to encircle a stationary vehicle along a horizontal plane, wherein the belt comprises at least one high-visibility portion, wherein the belt comprises at least one elastic portion to aid in attaching the belt to the stationary vehicle, wherein the belt is visible to other drivers when attached to the stationary vehicle, an elevated warning sign for placement in the vicinity of the stationary vehicle, and an beacon configured to be supported by the stationary vehicle.

The present disclosure also generally relates to a method of alerting other drivers on the highway of a stationary vehicle comprising providing a highway alert safety kit including a plurality of major components including a vehicle safety belt, an elevated warning sign and a beacon, wherein the vehicle safety belt is configured to encircle a stationary vehicle along a horizontal plane, wherein the belt comprises at least one high-visibility portion, wherein the belt comprises at least one elastic portion to aid in attaching the belt to the stationary vehicle, wherein the belt is visible to other drivers when attached to the stationary vehicle, wherein the elevated warning sign is for placement in the vicinity of the stationary vehicle, and wherein the beacon is configured to be supported by the stationary vehicle, alerting other drivers on the highway to the presence of the stationary vehicle through the plurality of major components, and assisting other drivers to evade or avoid a hazardous condition by alerting other drivers of the stationary vehicle before other drivers reach the stationary vehicle.

### DETAILED DESCRIPTION OF THE EXEMPLARY EMBODIMENTS

The embodiments disclosed below are not intended to be exhaustive or limit the disclosure to the precise forms disclosed in the following detailed description. Rather, the embodiments are chosen and described so that others skilled in the art may utilize their teachings.

Highway Alert Safety Kit (“HASK”) and HASK Jr.

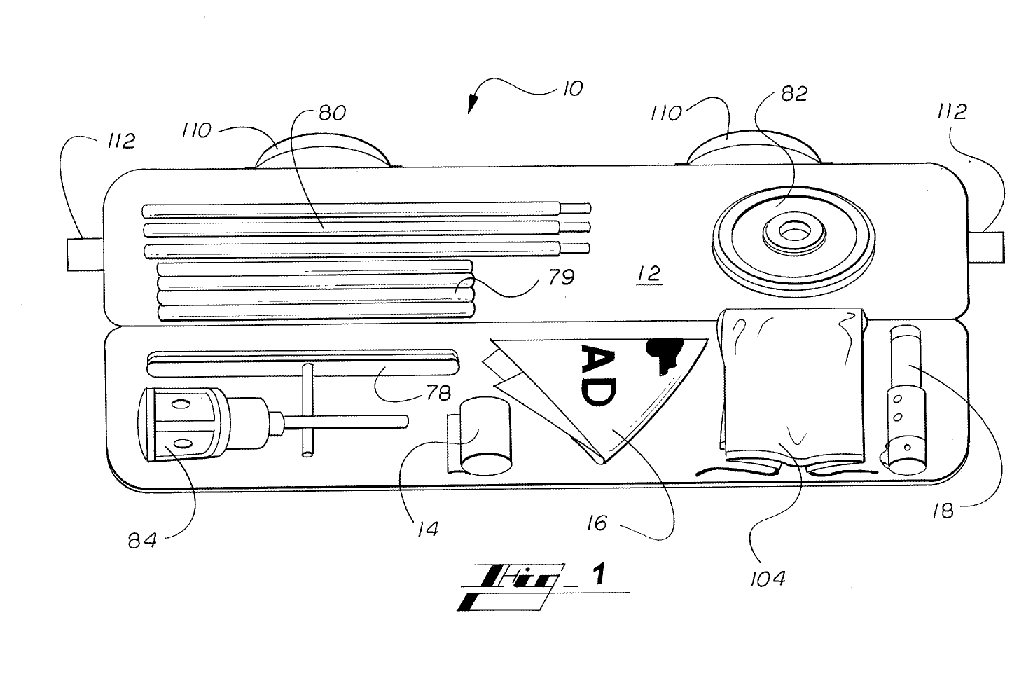

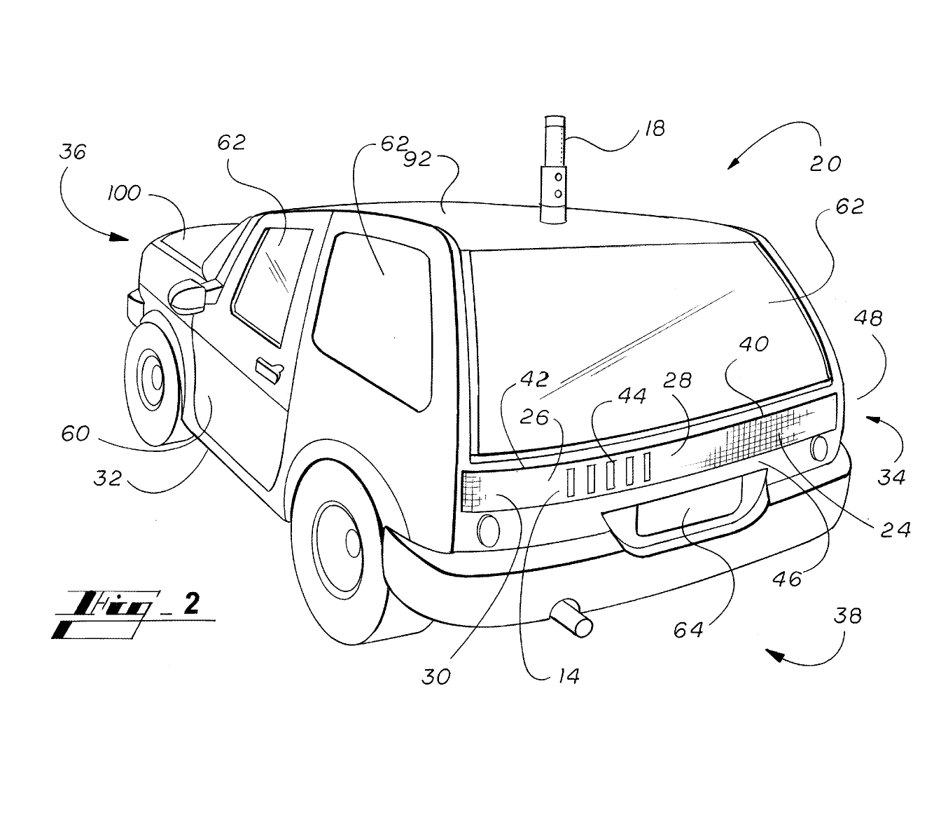

Referring to FIG. 1, major components of highway alert safety kit (HASK) 10 are shown within carrying case 12. HASK 10 is configured to alert other drivers on the highway to the presence of the stationary vehicle through the use of these major components and additional components. HASK 10 is also configured to assist other drivers to evade or avoid a hazardous condition by alerting other drivers of the stationary vehicle before other drivers reach the stationary vehicle.

Major components of HASK 10 include vehicle safety belt 14, elevated warning sign 16 and beacon 18. Each of the major components, vehicle safety belt 14, elevated warning sign 16, and beacon 18 may be useful to alert other drivers to the presence of stationary vehicle 20. HASK 10 is configured to utilize a plurality of these major components, such as at least two of the plurality of major components, for the intended purpose of alerting other drivers. Each major component and additional components are discussed in greater detail below.

Major components of HASK Jr. 22 include vehicle safety belt 14 and beacon 18.

Vehicle Safety Belt With High Visibility

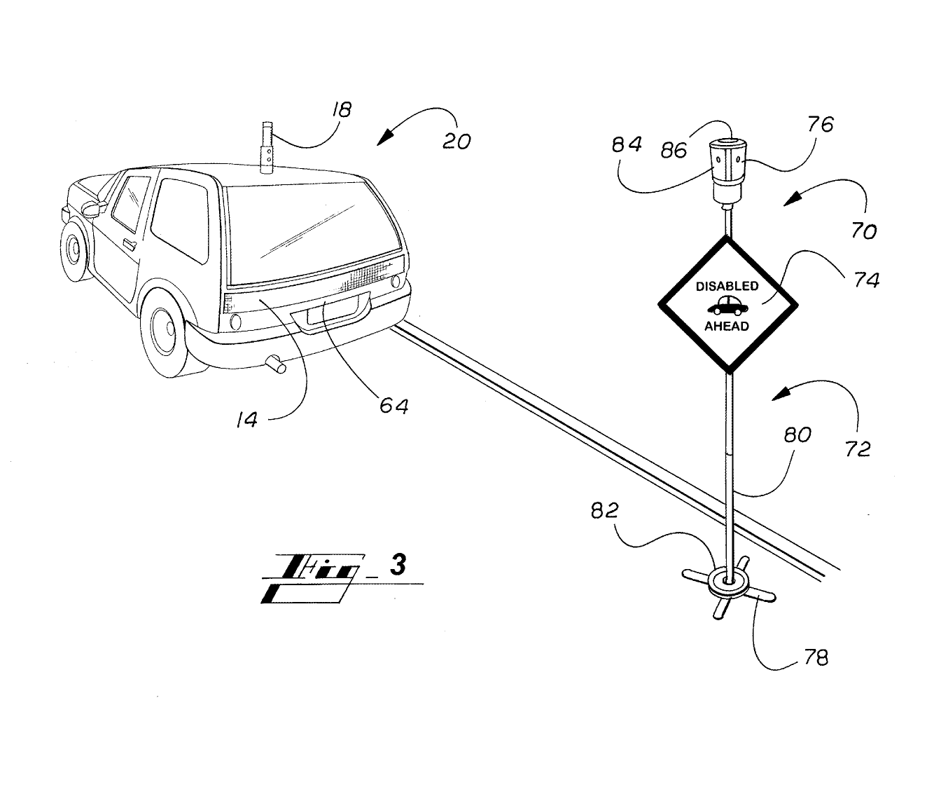

Referring to FIG. 2, vehicle safety belt 14 provides a mechanism for alerting other drivers to stationary vehicle 20. Vehicle safety belt 14 comprises (i) at least one high-visibility portion 24 which in use is visible to other drivers and (ii) at least one elastic portion 26 which attaches vehicle safety belt 14 to vehicle 20. In another embodiment the vehicle safety belt is made of material which is both elastic and also highly visible.

Vehicle safety belt 14 includes at least one high-visibility portion 24. High visibility portion 24 may be brightly colored, reflective, fluorescent, any combination thereof, or any other similar material. High visibility material can be of various types and many are known and in use on existing safety clothing or equipment. For example, vehicle safety belt 14 can comprise material which is brightly colored or reflective or both brightly colored and reflective. Other similar material can be day-glo colored. Brightly colored includes any color that is visible even under low light conditions such as white, yellow, orange, red or combinations of one or more of these colors. Other effective safety colors are also suitable. Vehicle safety belt 14 can additionally be made of or comprise material to which a reflective coating has been applied—either to vehicle safety belt 14 or to a part of vehicle safety belt 14. In one embodiment vehicle safety belt 14 comprises a strip of brightly colored material and a strip of reflective material. In one specific embodiment, vehicle safety belt 14 comprises yellow fluorescent material.

Vehicle safety belt 14 may comprise an elastic, high-visibility sign 28 across portion 30 of either side 32 or 34, front 36 or rear 38 of vehicle 20. Vehicle safety belt 14 may comprise elastic band 40. Band 40 may be made of or may comprise high-visibility material 42 so as to present one or more highly-visible lines 44 across a portion of vehicle 20. Application of vehicle safety belt 14 to vehicle 20 may comprise stretching vehicle safety belt 14 over portion 30 of vehicle 20. In use, belt 14 presents highly visible indicator 46 of stationary vehicle 20. In some embodiments, vehicle safety belt 14 is applied horizontally to stationary vehicle 20.

Vehicle safety belt 14 optionally includes elastic band 40 made of or comprising high-visibility material 42 which fits, when stretched, over portion 30 of either side 32 or 34, front 36 or rear 38 of vehicle 20. Using vehicle safety belt 14, highly visible alert 48 is easily attached to stationary vehicle 20, such as car 20. Other drivers 50 may be able see vehicle 20 due to vehicle safety belt 14. Other drivers 50 may then ensure that they do not drive too close to stationary vehicle 20 or to area 52 surrounding stationary vehicle 20. Other drivers 50 may be able to see stationary vehicle 20 early enough to take evasive or other avoiding action. Vehicle safety belt 14 can be quickly attached.

Several different embodiments of vehicle safety belt 14 are designed for different types of vehicles 20 such as car 20. Vehicle safety belt 14 is configured to generally apply to road vehicles, typically motorized ones. In different embodiments vehicle safety belt 14 are adapted for use on road vehicles 20 such as cars, vans, light goods vehicles, trucks, pick-up trucks, sports utility vehicles and motorcycles. Vehicle safety belt 14 can also be used on non-motorized vehicles such as trailers, caravans and the like. Vehicle safety belt 14 is well suited to smaller vehicles such as cars, vans, light goods vehicles and sports utility vehicles.

In yet another embodiment, vehicle safety belt 14 is in the form of loop 54 to which two ends 56 are attached to each other. Ends 56 may be wholly or partially elastic. Each end 56 can be releasably connected to each other. Various forms of releasable connection are suitable for connecting the free ends of the arms. In an exemplary embodiment of the invention, each end 56 comprises a strip of a hook and loop fastener e.g. Velcro™, allowing ends 56 to be joined to each other. An advantage of connecting ends 56 using a hook and loop fastener, such as Velcro™, is that there is little to no risk of scratching vehicle 20 when fitting or removing vehicle safety belt 14.

In yet another embodiment, each end 56 has connector 58 for attachment to stationary vehicle 20, for example for attachment to a car window, car window frame, wheel well, luggage rack. In additional embodiments ends 56 attach to hand grips (not shown) or seat belts (not shown) inside vehicle 20 via connector 58 such as a hook or buckle.

In one embodiment, a method of attaching vehicle safety belt 14 comprises vehicle safety belt 14 including loop 54 with two ends 56. The method of attaching vehicle safety belt 14 comprises attaching end 56 to stationary vehicle 20, stretching vehicle safety belt 14 around portion 30 of vehicle 20, and attaching second end 56 to stationary vehicle 20. Ends 56 can be attached to vehicle 20 by a number of mechanisms, for example, by shutting ends 56 in rear doors 60 or windows 62 of vehicle 20 or by tying ends 56 to attachment-like portions (not shown) of vehicle 20.

In another embodiment, a method of attaching vehicle safety belt 14 comprises stretching vehicle safety belt 14 around portion 30 of vehicle 20, stretching ends 56 of vehicle safety belt 14 to respective driver side 32 and passenger side 32 of vehicle 20, passing ends 56 through respective driver side 32 and passenger side windows 62 of vehicle 20 and attaching ends 56 to each other 56. As will be appreciated, this method of attaching vehicle safety belt 14 is more easily achieved when at least two people work together to attach vehicle safety belt 14 to vehicle 20.

In yet another embodiment, a method of attaching vehicle safety belt 14 comprises stretching vehicle safety belt 14 around portion 30 of vehicle 20, stretching ends 56 of vehicle safety belt 14 to respective driver side 32 and passenger side 32 of vehicle 20, passing ends 56 through respective driver side 32 and passenger side doors 60 of vehicle 20, attaching ends 56 to each other and/or closing doors 60.

In yet another embodiment, a method of attaching vehicle safety belt 14 comprises stretching vehicle safety belt 14 around portion 30 of vehicle 20, stretching ends 56 of vehicle safety belt 14 to respective driver side 32 and passenger side 32 of trunk 64 of vehicle 20, passing ends 56 through respective driver side 32 and passenger side 32 of trunk 64 of vehicle 20, attaching ends 56 to each other and/or closing trunk 64.

Vehicle safety belt 14 can be fitted to any door 60 or trunk 64 of vehicle 20 without inhibiting access to vehicle 20. Provided that vehicle safety belt 14 is fitted correctly, door 60 or trunk 64 will open, close and lock as usual.

Vehicle safety belt 14 may comprise a range of sizes. Vehicle safety belt 14 may be from approximately 1 inch to approximately 15 inches wide, such as from approximately 2 inches to approximately 10 inches wide, such as from approximately 3 inches to approximately 5 inches wide. In an exemplary embodiment, vehicle safety belt 14 is about 4 inches wide.

Vehicle safety belt 14 length may be adjustable according to its intended use and may include components such as an adjustable strap. Particular embodiments made for use with cars may include suitable lengths from approximately 100 inches to approximately 200 inches, such as from approximately 125 inches to approximately 150 inches, such as approximately 130 inches in length. One exemplary embodiment includes vehicle safety belt 14 that is approximately 138 inches long.

Warning Sign Placed in Elevated Position

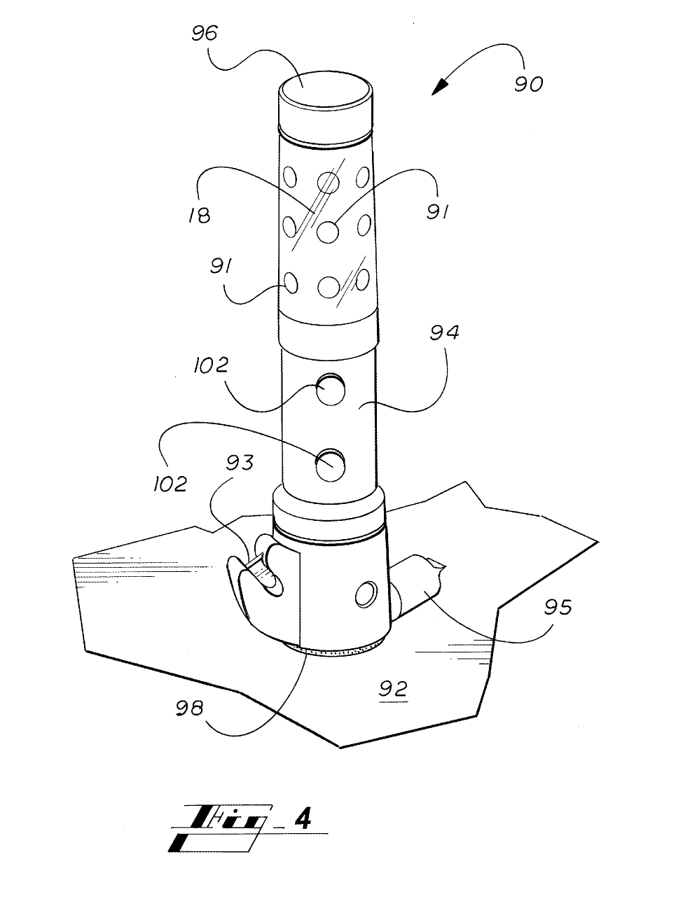

Referring to FIG. 3, warning system 70 includes warning stand 72, warning sign 74 and optional warning light 76. Warning stand 72 includes base 78 and frame members 79 and optionally includes a plurality of extension poles 80. Base 78 coupled to at least one of the plurality of extension poles 80 keeps warning sign 74 upright and elevated above the ground. Frame members 79 support and keep warning sign 74 flat and in a display type configuration.

As shown in FIG. 1, base 78 is illustrated as in a collapsed configuration. As best illustrated by FIG. 3, base 78 is shown in an operational configuration. The structure of base 78 is exemplary. Any base is sufficient that can support elevated warning sign 16 with or without extension poles 80 or warning light 76. FIG. 1 illustrates three extension poles 80. Each extension pole 80 is approximately two feet (2′) long. Inclusion and use of any number of extension poles 80 and extension poles 80 of any length are envisioned.

The reflector plates are batten shaped and along their longer edges they have lips that run lengthways and parallel to one another, designed to slide into their relative slots made in the frame along the longer rimmed edges of each strip that makes it up.

It is evident that these lips and their corresponding slots can have any kind of shape whatsoever and their cross section can therefore differ to the shape.

Warning sign 74 is configured to be supported by warning stand 72. Warning sign 74 is illustrated as diamond shaped and includes a message, such as “Disabled Vehicle Ahead”. It is envisioned that warning sign 74 may take a number of shapes, such as square, rectangular, diamond, circular, or oval. It is also envisioned that warning sign 74 may take a number of sizes such as 24 inches by 24 inches, 36 inches by 24 inches, 36 inches by 36 inches. It is envisioned that warning sign 74 may or may not include a message. Warning sign 74 can comprise material which is brightly colored or reflective or both brightly colored and reflective. Other similar material can be day-glo colored. Brightly colored includes any color that is visible even under low light conditions such as white, yellow, orange, red or combinations of one or more of these colors.

Any form of attaching warning sign 74 to warning stand 72 is envisioned including a fastener (not shown). Warning stand 72 supports warning sign 74 in an elevated position. By elevated position, it is envisioned that warning sign 74 may be more than approximately two feet from the ground. It is also envisioned that warning sign 74 may be higher than approximately six feet from the ground.

Elevated warning sign 74 may be beneficial for an unobstructed view by other drivers 50. Obstructions such as other vehicles, obstacles, and blind spots may be alleviated by elevated warning sign 74.

Weight 82 is approximately ten pounds (10 lbs). However, any weight is sufficient that can keep warning stand 72 from falling over due to forces such as wind. Weight 82 is also illustrated as a round doughnut hole configuration. The structure of weight 82 is exemplary. Any weight 82 which can fastened to, laid on, hang from, support or be supported by warning stand 72 is envisioned.

Warning light 76 is configured to be supported by warning stand 72. Warning light 76 also includes warning light extension pole 80 configured to attach to either base 78 or any number of extension poles 80 of warning stand 72. Warning light extension pole 80 is approximately one foot (1′) long. Any length of warning light extension pole 80 is envisioned.

Warning light 76 includes an optional lighted member 84, which can be an LED or other light source. Warning light 76 shown as amber light though other colors are envisioned. The use of an elevated warning light 76 particularly in a night-time situation can aid in seeing the alert and concomitantly, vehicle 20. The light source may be powered by a power source such as a battery or by extension to vehicle's car battery.

Warning system 70 can also be used without electric power for instance if the broken-down vehicle's electrical power source is out of order. It will be understood that other means of allowing warning system 70 to be viewed in dim or low light, such as luminescent materials and indirect lighting means, can be employed in kit 86 of the present disclosure without departing from its novel scope. Furthermore a more simple embodiment having no illumination is also contemplated.

Warning stand 72 supports warning light 76 in an elevated position. By elevated position, it is envisioned that warning light 76 may be more than approximately three feet from the ground. It is also envisioned that warning sign 74 may be higher than approximately seven feet from the ground.

In operation, warning sign 74 and warning light 76 are supported by warning stand 72 within the vicinity of stationary vehicle 20. In one embodiment, warning system 70 is located such that other drivers may see warning system 70 before seeing stationary vehicle 20, such as approximately several hundred feet or yards or meters toward oncoming traffic. When vehicle 20 has stopped on a bend, warning system 70 can be placed before the beginning of the bend to increase the warning provided to other drivers.

Emergency Light Supported by Vehicle

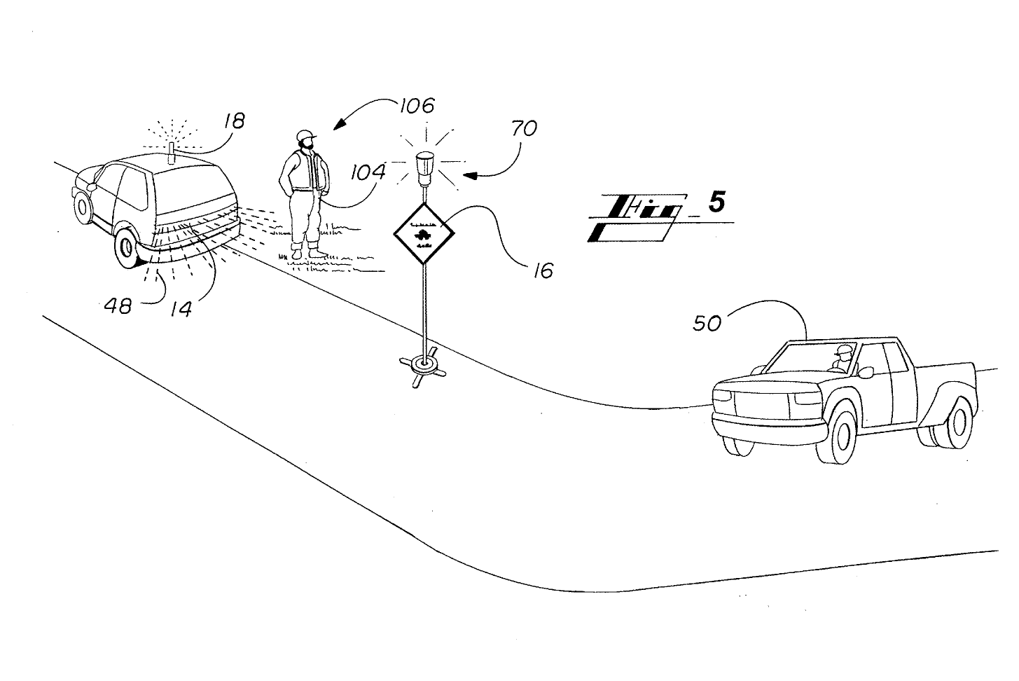

Referring now to FIGS. 2, 3, 4 and 5, in which similar or corresponding parts are identified with the same reference numeral, emergency light 90 is shown supported by roof 92 of vehicle 20. As shown in FIGS. 4, 5, and 6, emergency light 90, supported by vehicle 20, provides visual alerting to other drivers using beacon 18. As shown in FIG. 4, emergency light 90 includes control panel 94, beacon 18, and flashlight 96. Beacon 18 provides light non-parallel to the longitudinal axis of emergency light 90. Stated in a another way, beacon 18 provides at least a portion of light perpendicular to the longitudinal axis of emergency light 90. Stated in yet another way, beacon 18 provides at least a majority of light at an angle to the longitudinal axis of emergency light 90.

While beacon 18 is described utilizing a plurality of individual lights, various other methods for producing the desired illuminated area could be utilized, such as neon light, LEDs, such as amber LED bulbs 91, liquid crystal, or the like. LED bulbs 91 are organized as three bulbs 91 per column which is parallel along the longitudinal axis of beacon 18. As illustrated there are four columns separated by 90 degrees from each other providing light in every direction perpendicular to the longitudinal axis of emergency light 90. Use of elevated emergency light 90 particularly in a night-time situation can aid in seeing the alert and vehicle 20.

Emergency light 90 also includes razor 93 capable of cutting a seat belt (not shown). Emergency light 90 also includes glass break 95 illustrated as a metal probe.

Emergency light 90 also includes magnet 98 located within base end 56. Magnet 98 removeably secures emergency light 90 to metal objects, such as metal parts of vehicle 20 including roof 92, hood 100, trunk 64 of vehicle 20 without requiring a stand or other base which may damage the paint or surface of vehicle 20. Emergency light 90 may be powered by a power source such as a battery or by extension to vehicle's car battery. Electrical cord (not shown?) extends from emergency light 90 to the electrical system of vehicle 20.

Emergency light 90 of the kit 86 is lightweight, compact and capable of being stored in the glove compartment of vehicle 20.

FIG. 4 is an illustration of control panel 94. Control panel 94 includes push buttons 102 for beacon 18 and flashlight 96. Push buttons 102 are configured to select whether emergency light 90 provides light through function of beacon 18, flashlight 96 or some combination of beacon 18 and flashlight 96.

Flashlight 96 provides light substantially parallel to the longitudinal axis of emergency light 90. Stated in a another way, flashlight 96 provides at least a portion of light substantially parallel to the longitudinal axis of emergency light 90. Stated in yet another way, flashlight 96 provides at least a majority of light at substantially in line with the longitudinal axis of emergency light 90.

While flashlight 96 is described utilizing a plurality of individual lights, various other methods for producing the desired illuminated area could be utilized, such as neon light, LEDs, liquid crystal, or the like. Use of elevated emergency light 90 as flashlight 96 particularly in a night-time situation can aid in several ways, such as directing traffic away from vehicle 20, providing additional light for needed repairs to vehicle 20, providing additional light to assis in finding lost items.

Additional Components of Highway Alert Safety Kit (“HASK”)

Referring back to FIG. 1, additional components of highway alert safety kit (HASK) 10 are shown within carrying case 12. Additional components of HASK 10 include carrying case 12, and safety vest 104. Major components of HASK Jr. 22 are also shown within carrying case 12. A separate carrying case for HASK, Jr. 22 is also envisioned but not illustrated.

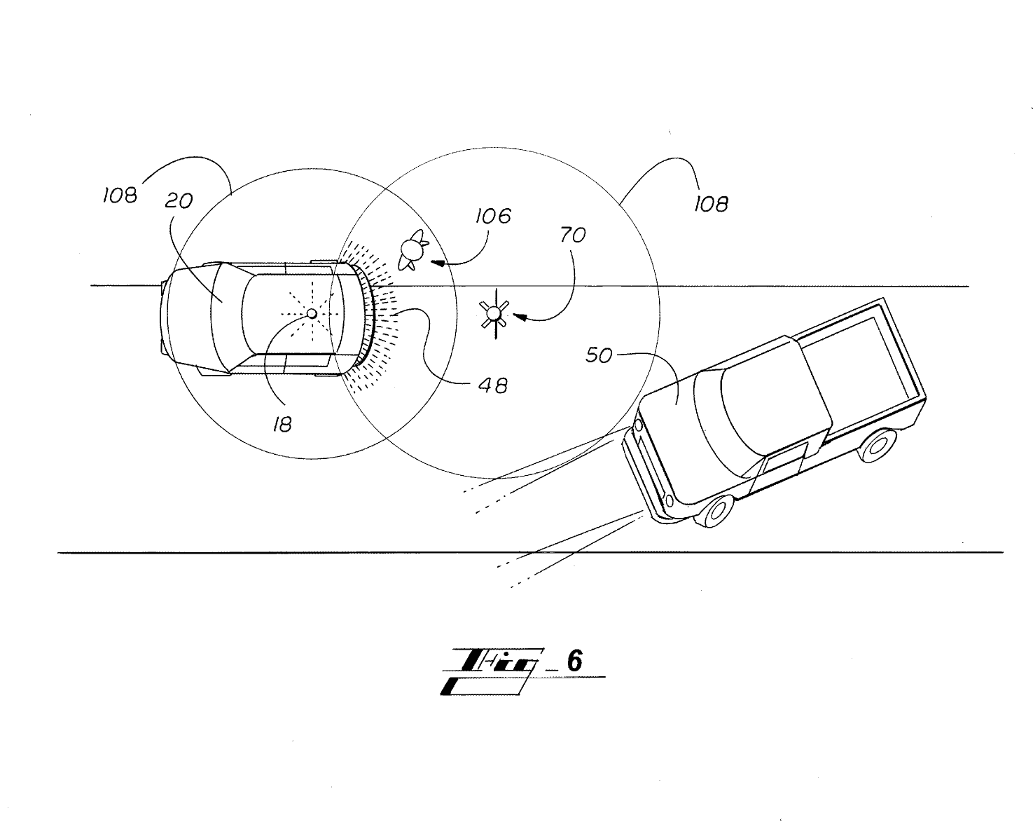

Referring to FIG. 5, safety vest 104 may be useful to alert other drivers to the presence of wearer 106. Safety vest 104, along with other components of HASK 10 and HASK Jr. 22 provide a mechanism for alerting other drivers to stationary vehicle 20.

Safety vest 104 comprises at least one high-visibility portion 24 which in use is visible to other drivers. High visibility portion 24 may be brightly colored, reflective, fluorescent, any combination thereof, or any other similar material. High visibility material can be of various types and many are known and in use on existing safety clothing or equipment. For example, safety vest 104 can comprise material which is brightly colored or reflective or both brightly colored and reflective. Other similar material can be day-glo colored. Brightly colored includes any color that is visible even under low light conditions such as white, yellow, orange, red or combinations of one or more of these colors. Other effective safety colors are also suitable.

Safety vest 104 can additionally be made of or comprise material to which a reflective coating has been applied—either to safety vest 104 or to a part of safety vest 104. In one embodiment safety vest 104 comprises a strip of brightly colored material and a strip of reflective material. In one specific embodiment, safety vest 104 comprises yellow fluorescent material. In another embodiment safety vest 104 is made of material which is highly visible.

Carrying case 12 includes handles 110 and fasteners 112. Fasteners 112 may comprise hook and loop fastener material, e.g. Velcro™, allowing fasteners 112 to be joined to each other folding carrying case 12 approximately in half.

Operation of Highway Alert Safety Kit (“HASK”) and HASK Jr.

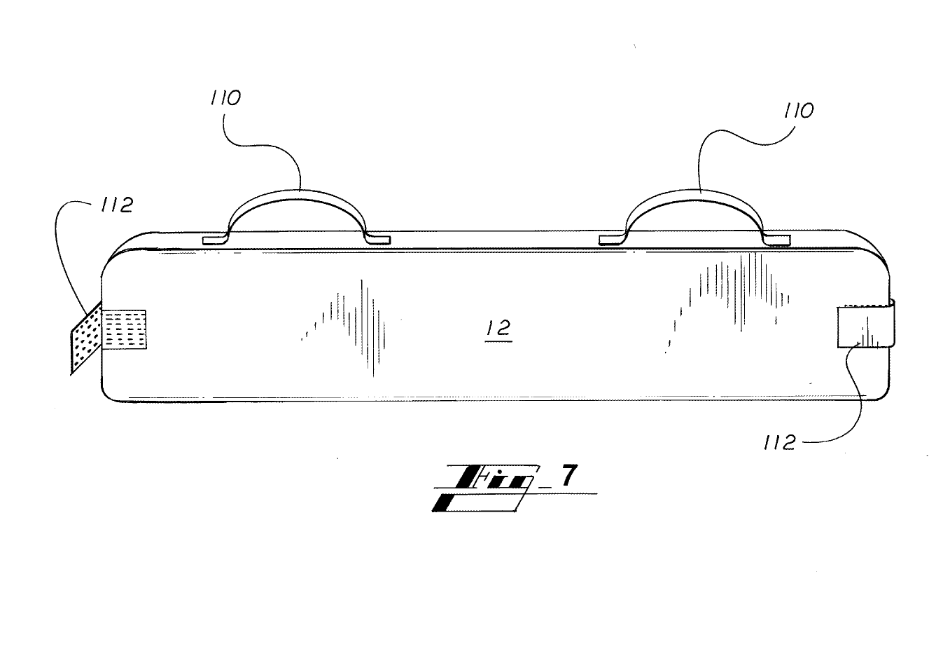

Referring to FIG. 6, highway alert safety kit (HASK) 10 is shown to alert other drivers to stationary vehicle 20. As previously discussed, HASK 10 is configured to alert other drivers on the highway to the presence of the stationary vehicle through the use of these major components and additional components. Referring to FIG. 6, HASK 10 is also configured to assist other drivers to evade or avoid a hazardous condition by alerting other drivers of stationary vehicle 20 before other drivers reach stationary vehicle 20.

As previously discussed, each of the major components, vehicle safety belt 14, elevated warning sign 16, and beacon 18 may be useful to alert other drivers to the presence of stationary vehicle 20. HASK 10 is configured to utilize a plurality of these major components, such as at least two of the plurality of major components, for the intended purpose of alerting other drivers. It is envisioned that any two components of the plurality of major and additional components of HASK 10 are sufficient to alert and assist other drivers.

While the novel technology has been illustrated and described in detail in the figures and foregoing description, the same is to be considered as illustrative and not restrictive in character, it being understood that only the preferred embodiments have been shown and described and that all changes and modifications that come within the spirit of the novel technology are desired to be protected. As well, while the novel technology was illustrated using specific examples, theoretical arguments, accounts, and illustrations, these illustrations and the accompanying discussion should by no means be interpreted as limiting the technology. All patents, patent applications, and references to texts, scientific treatises, publications, and the like referenced in this application are incorporated herein by reference in their entirety.

While this disclosure has been described as having an exemplary design, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains.

I claim:

1. A highway alert safety kit comprising:
a vehicle safety belt configured to encircle a stationary vehicle along a horizontal plane, wherein the belt comprises at least one high-visibility portion, wherein the belt comprises at least one elastic portion to aid in attaching the belt to the stationary vehicle, wherein the belt is visible to other drivers when attached to the stationary vehicle,
an elevated warning sign for placement in the vicinity of the stationary vehicle, and
an emergency light configured to be supported by the stationary vehicle, the emergency light including a beacon.

2. The kit of claim 1, wherein the belt includes ends which are releasably connected to each other.

3. The kit of claim 2, wherein the ends include hook and loop fasteners.

4. The kit of claim 1, wherein the belt includes material which is brightly colored, reflective, or any combination thereof.

5. The kit of claim 4, wherein the material is yellow, orange, white, or red.

6. The kit of claim 1, wherein the elevated warning sign is supported in its elevated position by a warning stand.

7. The kit of claim 6, wherein the elevated warning sign is at least two feet above the ground.

8. The kit of claim 6, further comprising a weight for use to anchor the stand.

9. The kit of claim 6, further comprising a warning light adjacent to the elevated warning sign, the warning light supported by the stand.

10. The kit of claim 1, wherein the emergency light works as a flashlight.

11. The kit of claim 1, further comprising a safety vest for use by an occupant of the vehicle.

12. A method of alerting other drivers on the highway of a stationary vehicle comprising:
providing a highway alert safety kit including a plurality of major components including a vehicle safety belt, an elevated warning sign and an emergency light,
wherein the vehicle safety belt is configured to encircle a stationary vehicle along a horizontal plane, wherein the belt comprises at least one high-visibility portion, wherein the belt comprises at least one elastic portion to aid in attaching the belt to the stationary vehicle, wherein the belt is visible to other drivers when attached to the stationary vehicle,
wherein the elevated warning sign is for placement in the vicinity of the stationary vehicle, and
wherein the emergency light is configured to be supported by the stationary vehicle,
alerting other drivers on the highway to the presence of the stationary vehicle through the plurality of major components, and
assisting other drivers to evade or avoid a hazardous condition by alerting other drivers of the stationary vehicle before other drivers reach the stationary vehicle.

13. The method of claim 12, further comprising the step of utilizing at least two of the plurality of major components.

14. The method of claim 12, further comprising the step of applying the vehicle safety belt to the stationary vehicle.

15. The method of claim 14, wherein the vehicle safety belt is applied to the stationary vehicle by releasably connecting belt ends to each other.

16. The method of claim 14, wherein the vehicle safety belt is applied to the stationary vehicle by shutting belt ends in doors or windows of the vehicle.

17. The method of claim 14, wherein the vehicle safety belt is applied to the stationary vehicle by attaching belt ends to attachment-like portions of the vehicle.

18. The method of claim 12, wherein the emergency light is supported by the stationary vehicle.

19. The method of claim 12, wherein the emergency light is used as a flashlight.

20. The method of claim 12, further comprising providing a safety vest for use by an occupant of the vehicle.
